(19) United States
(12) Patent Application Publication
(10) Pub. No.: US 2015/0081495 A1
(43) Pub. Date: Mar. 19, 2015

(54) System and Method for Account Succession

(71) Applicant: Barclays Bank PLC, London (GB)

(72) Inventor: Lee Randall, Princes Risborough (GB)

(21) Appl. No.: 14/031,422

(22) Filed: Sep. 19, 2013

(51) Int. Cl. G06Q 40/02; G10L 17/00

(52) U.S. Cl. CPC G06Q 40/02; G10L 17/00
USPC 705/35

(57) ABSTRACT

A system for secured succession of a user account to an authorized successor, including a database storing data identifying a registered successor for an account and associated data defining a biometric signature of the registered successor, a verification module configured to verify the identity of the registered successor based on the biometric signature, and an account transfer module configured to receive an instruction to transfer the account to the registered successor, and to transfer the account to the registered successor after verification of the identity of the successor by the verification module.

### FIELD OF THE INVENTION

This invention relates to account management in a financial system, and more particularly to facilitating transfer of a user's financial account to an authorized successor.

### BACKGROUND OF THE INVENTION

Fraudulent account takeover causes the financial industry significant losses every year. Consequently, conventional account succession requires stringent checks on physical evidence provided by the authorized successor before a financial institution approves takeover of the account and access to the associated funds. Typical forms of evidence are a death certificate, waiver of probate, letter of indemnity, a Power of Attorney, a grant of representation, and in the case of larger account holdings, a letter of clearance from a Revenue Commission. Unfortunately, legitimate account takeover is hindered by such stringent controls. Moreover, financial institutions will typically freeze an account immediately on receiving notice that the associated account holder is deceased or otherwise incapacitated, often, requiring involvement of an agent or representative to assist with probate recovery before access to the funds can be granted to approved next-of-kin. The burden and associated delays can be particularly undesirable and distressing to individuals in the event of account succession resulting from an emotionally challenging event, such as following recognition of mental incapacity in, or passing of, a loved one.

What is desired is an efficient process for facilitating efficient account succession without being exposed to potential fraudulent losses.

### SUMMARY OF THE INVENTION

According to one aspect of the present invention, a system is provided for the secured succession of a user account to an authorized successor. The system includes a database storing data identifying a registered successor for an account and associated data defining a voice signature of the registered successor, The system also includes a verification module configured to verify the identity of the registered successor based on the voice signature. Finally, an account transfer module is configured to receive an instruction to transfer the account to the registered successor, and to transfer the account to the registered successor after verification of the identity of the successor by the verification module.

In another aspect, the present invention provides a computer-implemented method for the secured succession of a user account to an authorized successor. The method includes storing data identifying a registered successor for an account and associated data defining a voice sip-nature of the registered successor, verifying the identity of the registered successor based on the voice signature, receiving an instruction to transfer the account to the registered successor, and transferring the account to the registered successor after verification of the identity of the successor.

In other aspects, there is provided a computer program and computing device arranged to carry out the method when executed by suitable programmable devices, and a non-transitory storage medium comprising the computer program.

### BRIEF DESCRIPTION OF THE DRAWINGS

There now follows, by way of example only, a detailed description of embodiments of the present invention, with references to the following figures identified below:

FIG. 1 is a block diagram showing the main components of an account management system according to an embodiment of the invention;

FIG. 2 is a flow diagram illustrating the main processing steps performed by the system of FIG. 1 for a successor account registration process according to an embodiment;

FIG. 3 is a flow diagram illustrating the main processing steps performed by the system of FIG. 1 for an account succession process according to an embodiment; and

FIG. 4 is a diagram of an example of a computer system on which one or more of the functions of the embodiment may be implemented.

### DETAILED DESCRIPTION OF THE INVENTION

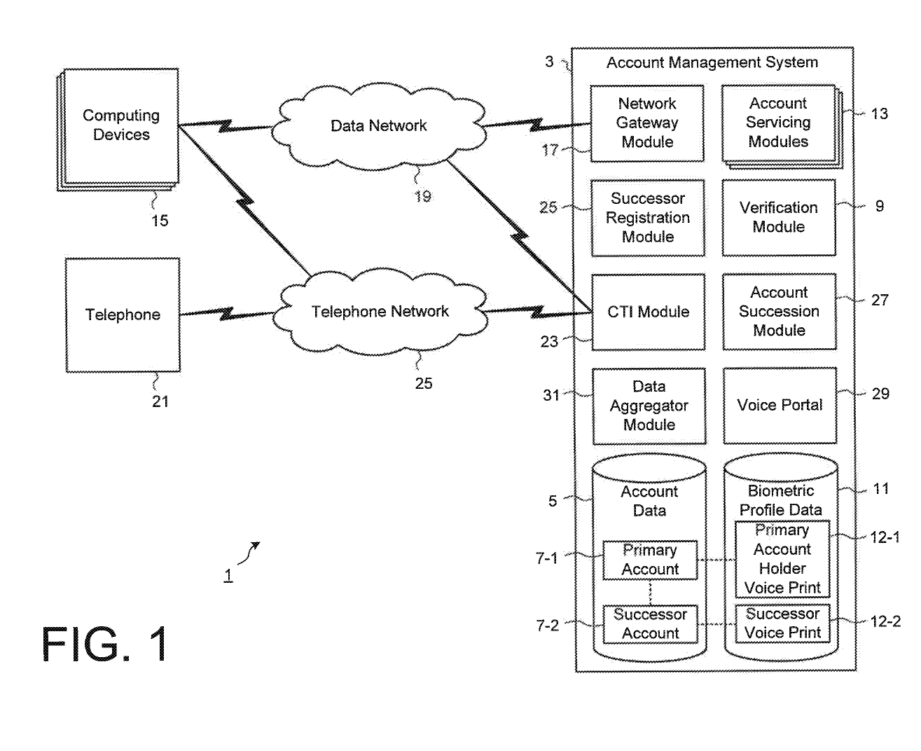

A specific embodiment of the invention will now be described for the process of secured succession of a customer's account to an authorized successor. Referring to FIG. 1, an account management environment 1 according to an embodiment includes an account management system 3 with an accounts database 5 storing account data associated with a plurality of user accounts, in particular, a primary account 7-1 and a successor account 7-2. In this embodiment, the account management system 3 is associated with a financial institution and the user accounts 7-1, 7-2 are financial accounts associated with funds that are accessible by the registered account holder after verification of the account holder's identity by a verification module 9. The account data associated with the user accounts 7-1, 7-2 may be stored as part of a Customer Relationship Management (CRM) system of the financial institution, as is known in the art.

The verification module 9 is configured to perform any one or more forms of user identification and verification (ID&V) mechanism. For example, typical ID&V involves challenge questions and response, validation of the account or an associated card number, a Personal Identification Number (PIN) and/or a secret word. As another example, verification of an account bolder identity involves verification of the account holder's biometric profile based on stored biometric data 11 associated with account data of the. user accounts 7-1, 7-2 5, such as voice print data 12 derived from captured voice data from the account holder, and/or facial profile data derived from captured image data. As is known in the art, a voice print 13 can be defined as a mathematically described set of speech characteristics of a human voice, such as frequency, pitch, speed, word pronunciation, dialect, etc., and a facial profile 15 can be defined as a mathematically described set of visual characteristics of a human face, such as relative position, size and/or shape of the eyes, nose, cheekbones, jaw, etc., skin, colour, shade or tone, etc. Such ID&V mechanisms are of a type that are known per se, and will not be described further.

Optionally, the verification module 9 can be configured to perform enhanced verification based on a six factor authentication process. In addition to the typical three factors of:
‘something you are’: e.g. biometric authentication
‘something you know’: e.g. password, PIN, date of birth, etc.
‘something you have’: e.g. authentication token such as a credit card or RSA SecurID token, mobile phone, etc.
   the verification module 9 can require the following additional three factors of:
‘something the system predicts’: e.g. regular behaviors, associative behaviors
‘something the system finds out’: e.g. intentions posted on a social network, such as Facebook, Twitter, LinkedIn.
‘something the system infers’; e.g. group behaviors and dynamics such as splitting a bill/check.

The account management system 3 also includes one or more account servicing modules 13 for facilitating access to the financial accounts and servicing of the account data associated with the. user accounts 7-1, 7-2 by the respective verified account holders, for example, to retrieve and update address and telephone contact details, retrieve account balances, instruct transactions from the accounts, or the like. The account management system 3 is also he configured to store and/or maintain supplemental data associated with or indexed to a user's account, for example:
social media/network or media events, commonly referred to as a news feed,
contact history, such as logged interactions with customer services agents or self-service enabled channels,
fraudulent transaction history, which can include flagged events and remediation action, failed customer services channel log-in/access attempts,
historical collections details, such as bad debt logs and missed payments,
contact preferences (SMS, email, twitter. Facebook, mobile phone, video call),
outbound campaign details, which can be collections or fraud related, or related to suspected/identified conditions of the account holder, such as an ailment or death.

The registered account holders can access the various account servicing modules 13 from computing devices 15, such as a personal computer, a laptop, a computing terminal, a smart phone, a tablet computer, or the like, in electronic communication with a network gateway module 17 of the account management system 3 via a data network 19. The data network 19 may be any suitable data communication network such as a wireless network, a local- or wide-area network including a corporate intranet or the Internet, using for example, the TCP/IP protocol, or a cellular communication network such as Global System for Mobile Communications (GSM). General Packet Radio Service (GPRS), Code Division Multiple Access (CDMA), CDMA2000, Enhanced Data Rates for GSM Evolution (EDGE), Evolved High-Speed Packet Access (HSPTA+), Long Term Evolution (LTE), etc.

Additionally or alternatively, the registered account holders can access the account servicing modules 13 through a telephone 21 connected to a Computer Telephony Integration (CTI) module 23 of the account management system 3 that facilitates interactions between the telephone 21 and the account management system 3 via a telephone network 25, such as a public switched telephone network (PSTN). As is known in the art, the CTI module 23 can be configured to handle interactions with a caller using interactive voice response (IVR) technology and to route telephone calls to one or more servicing modules 13.

As will he described below in greater detail, the account management system 3 includes a successor registration module 25 tor facilitating registration of an authorized successor for an existing primary account 7-1 and creation of a respective successor account 7-2, prior to and in anticipation of a need to transfer the primary account 74 to the authorized successor, for example, after bereavement or incapacitation of the associated primary account holder. The account management system 3 also includes an account succession module 27 for facilitating the transfer of access to, and control of, the primary account 7-1 to the pre-registered successor. The account succession module 27 is coupled to the verification module 9 to verify the identity of the pre-registered successor before the account succession is authorized and activated. The successor registration module 25 and the account succession module 27 are also coupled to the network gateway module 17 and the CTI module 23 to allow a nominated successor to communicate with the account management system 3 via an associated computing device 15 over the. data network 19, and/or telephone 21 over the telephone network 25.

The account management system 3 also includes a voice portal module 29 coupled to the CTI module 23 for capturing voice data from telephone calls by account holders to the account management system 3, for example, when calls are made to engage services provided by the account management system 3 via the CTI module 23, or when voice responses are received in response to verification challenges by the verification module 9. The voice portal module 29 may also be coupled to the network gateway module 17 to capture voice data received from a computing device 15, for example, via a microphone (not shown). Optionally, the voice print data 12 is maintained by the voice portal module 29, for example, by iteratively updating the voice prints 12 based on further voice-based interactions by the successor with any services provided the financial institution, thereby advantageously reducing biometric divergence of the stored biometric profile 11 from the successors voice print 12-2 over time. As a further option, stale voice prints, which are voice prints that have not been verified or updated within a predefined period of time, can be augmented by the voice portal module 29 by a variance prediction model to take into account predicted changes to the voice print for improved recognition and verification. Such predicted variance may reduce a security weighting for the biometric authentication factor and further ID&V questions may be required by the verification module 9.

Successor Account Registration Process

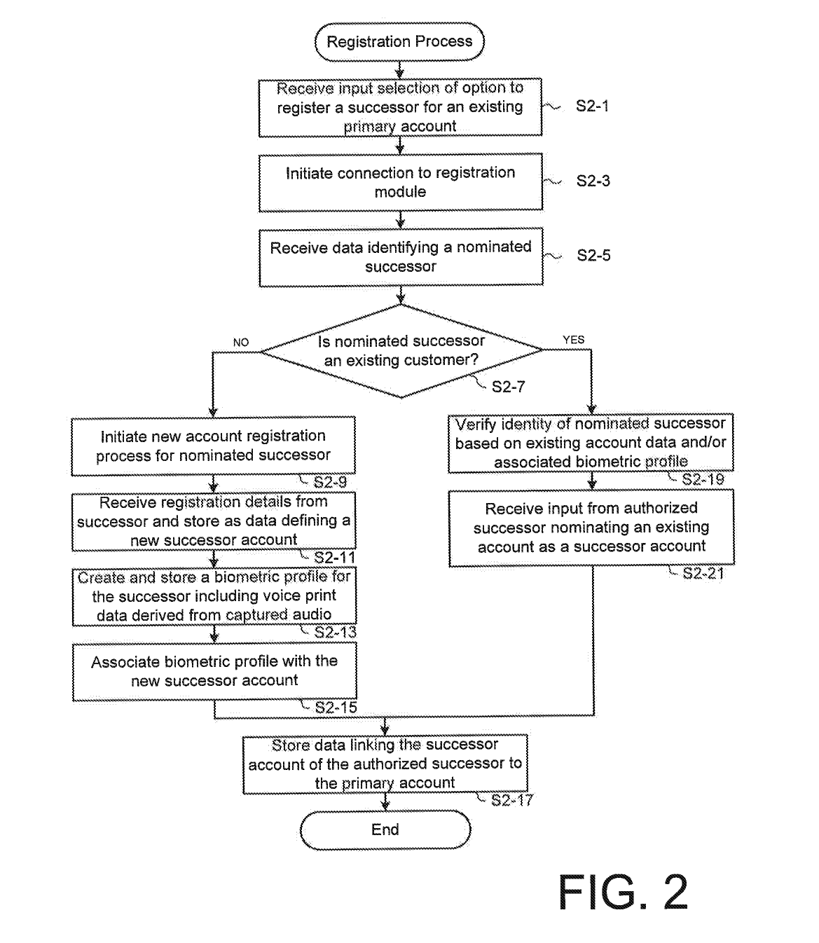

A brief description has been given above of the components forming part of the account management system 3 of this embodiment. A more detailed description of the operation of these components in this embodiment will now be given with reference to the flow diagram of FIG. 2, for an exemplary, computer-implemented successor account registration process, using the successor registration module 25.

As shown in FIG. 2, the process begins at step S2-1 where the network gateway module 17 receives input data from an instructor, the input data being indicative of a selection of an option to register a successor for an existing primary account 7-1. Preferably, the instructor is the registered holder of the primary account 7-1, acting as a testator wishing to register a nominated next-of-kin for the primary account. The instructor can provide input data to the account management system 3 from an application on the computer device 15, such as a web browser or a dedicated online account management software application. Alternatively, the input data can be received via the telephone 21 and the CTI module 23, through telephone keypad input and/or voice responses to IVR prompts. Optionally, the identity of the instructor can be verified by the verification module 9, for example by prompting the instructor to speak into the computing device 15 or telephone 21 to provide a voice sample, or to respond to one or more ID&V challenge questions,

At step S2-3, the network gateway module 17 establishes a connection to the successor registration module 25 to handle the request. At step S2-5, the successor registration module 25 prompts for and receives data identifying a nominated successor. This identifying data may be one or more of: a registered name, a postal address, a telephone number, an account number, a voice print, etc. At step S2-7, the successor registration module 25 determines from the received data, such as the account number, it the nominated successor is an existing customer having a registered account with the financial institution. If it is determined that the nominated successor is not an existing customer, then at step S2-9 the successor registration module 25 initiates a new account registration process to register and open a new successor account 7-2 for the nominated successor. At step S2-11, the successor registration module 25 receives registration details from the successor, creates and stores data for the new successor account 7-2 in the accounts database 5. The received registration details may be in the form of user input via an interface of the application or web interface on the computing device 15, the telephone 21 keypad, or captured audio responses to prompts from the successor registration module 25 via the CTI module 23. Preferably, key registration details for the nominated successor include information to allow follow-up questions such as home address, date of birth and contact details, and permission for pre-active contact to maintain the integrity of the stored data or query the status of the testator.

At step S2-13, the successor registration module 25 creates and stores a biometric profile 11 for the successor, if necessary, the biometric profile including a successor voice print 12-2 derived from voice data of the successor captured by the voice portal 29. As described above, the audio data can be captured from call data when the nominated successor connects to the successor registration module 25 using a telephone 21 via the CTI module 23. Alternatively, the successor registration module 25 can be configured to prompt tire successor for spoken responses through a biometric profile generation process in order to capture sufficient voice data to derive the voice print 12-2, for example, where the registration process does not otherwise, involve verbal input from the successor. The successor's stored biometric profile 11 is associated with the new successor account 7-2 by the successor registration module 25 at step S2-15, to complete, the new successor account registration process. For example, this can be implemented by storing data for the successor account 7-2 defining a link to the associated biometric profile.

At step S2-17, the successor registration module 25 stores data linking the authorized successor's account 7-2 to the existing primary account 7-1. For example, the successor registration module 25 can add a reference to the successor's account 7-2 in a successor account field of the primary account data 7-1.

On the other hand, if it is determined at step S2-7 that the nominated successor is an existing customer of the financial institution, then at step S2-19, the successor registration module 25 calls the verification module 9 to verify the identity of the nominated successor based on ID&V of the successors existing account data 7-2 and/or verification of captured voice data of the nominated successor compared to an associated stored voice print 12-2 of the successor's existing biometric profile 11. If the nominated successor has more than one existing account with the financial institution, then after the verification module 9 has verified the successor's identity, the successor registration module 25 cart prompt the authorized successor to nominate one of the existing accounts as the successor account 7-2. The nominated successor account 7-2 is then linked to the primary account 7-1 by the successor registration module 25 at step S2-17.

In an alternative embodiment, the successor registration module 25 is configured to register the voice print of a successor as discussed above and to then automatically convert the existing primary account 7-1 to a “Payable On Death” (POD) type of successor account 7-2 (also known as an “In-Trust-For” account). In this way, the account management system 3 leaves the existing account holder/owner in control of the associated funds and the ability to nominate a different successor at any time.

Account Succession Process

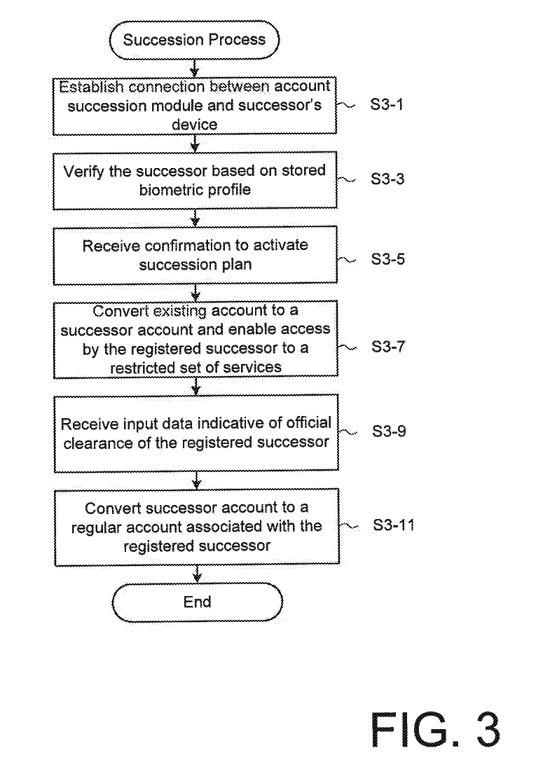

FIG. 3 is a flow diagram illustrating a computer-implemented process for handling succession of the existing primary account to the authorized successor pre-registered as described above. At step S3-1, the account management system 3 establishes a connection between the account succession module 27 and a registered successor's computing device 15 or telephone 21. In one embodiment, the successor contacts the account management system 3, for example, following the bereavement or incapacitating event of the primary account holder.

In an alternative embodiment, the account succession module 27 determines that a successor must be appointed for an existing account. This prediction of the need for account handover can be made based on available data from a plurality of various data sources (i.e. something the system finds out), in order to identify a candidate event associated with a registered account holder that potentially necessitates succession of the existing primary account 7-1. For example, the account management system 3 includes a news feed aggregator module 31 to monitor and provide data relating to:
“Close events”: e.g. announcement of illness by testator, successor, associates or press.
“High risk event association”: e.g. purchase of a train ticket, followed by press announcement of an accident involving a train run by the same operator.
“Passive events”: e.g. insurance and pension annuity lifespan calculations; when testator reaches a certain age fins would start to increase the weight given to the “something the system predicts” security factor, as well as potentially increasing the level of interest the financial institution has in monitoring this particular profile.
“Implied Events”: e.g. purchase of funeral services by Testator, Successor or known associates of either. This could be from the financial institution's own financial transaction monitoring ability or announcement on a social network.
“Explicit Events”: e.g. announcement of death by Testator, Successor or known associates of either.

In response to identifying a candidate event, the account succession module 27 determines the pre-registered successor from existing account data and pro-actively contacts the registered successor based on contact details stored in. the data of the successor account 7-2. Optionally, the account succession module 27 can prompt the registered successor for confirmation of the demise of the primary account holder. At step S3-3, the account succession module 27 calls the verification module 9 to verify the successor's identity based on the stored voice print 12-2 of the successor's biometric profile 11. Optionally, the verification module 9 can be configured to carry out ID&V based on the successor's stored account details. The level of verification required by the account succession module 27 at this step can depend on various factors, inducting whether the account management system 3 initiated contact with the registered successor, whether an initial IVR greeting and response by the registered successor provided a sufficient biometric voice sample, current business risk appetite, etc.

After the verification module 9 confirms that the contacted person is the authorized and registered successor for the primary account 7-1, the account succession module 27 can prompt the successor for confirmation to activate the succession plan. At step S3-5, the account succession module 27 receives confirmation from the successor and proceeds to migrate or convert the existing primary account 7-1 to a successor account 7-2 at step S3-7. Migration of the primary account 7-1 to a successor account 7-2 involves the transfer of associated funds and other payment artifacts, such as direct debits and standing orders, to the successor account, whereby the financial institution is able to divert communications to the registered successor and continues to honor existing bill payments, etc. The primary account 7-1 is also updated to include a link to the successor account 7-2 that may be used where appropriate, such as for diversion of contact details, notes/alerts for future customer services agents involved in handling the account and auditability of the primary account 7-1 based on data from the linked successor account 7-2. Optionally, the account succession module 27 can enable restricted access by the associated registered successor to the successor account 7-2 until a full probate process has completed, for example, by controlling access to the account servicing modules 13 such as limiting the transaction amounts or frequency from that account, prohibiting closure of the account, addition of a joint account holder, and/or creation of new payments of any type (e.g. standing order, direct debit, or single payment instructions).

It will be appreciated that a full probate process is typically carried out by an external entity, such as a Probate Court or by an agent/representative, or Revenue Commission, etc. to officially and legally authorize the executor of an estate (e.g. the successor or next-of-kin) to take full control of the affairs of the testator. Accordingly, at step S3-9, the account succession module 27 receives input data indicative of official clearance of the registered successor received from the external entity, such as data indicative of Grant of Representation, Probate Court access order, waiver of probate, indemnity, Power of Attorney, Revenue Commission clearance, etc. It will be appreciated that a period of time may pass between migration of the account to a successor account at step S3-7 and subsequent receiving of confirmation that the successor is officially cleared at S3-9. Once confirmation of the official clearance has been received, the account succession module 27 updates the account data 7 to migrate or convert the successor account 7-2 to a regular account associated wish the registered successor, whereby full and unrestricted access to the financial account is enabled.

The process for migration or conversion of the successor account 7-2 to a regular account will depend on the specific configuration of the account management environment 1, and may be implemented for example as a course-grained process of clearing a successor account flag from account details stored as part of a CRM system, or could be implemented in a more fine-grained manner by explicitly removing the individual restrictions from the successor account 7-2, such as the above-mentioned payment limits, account closure block controls, additional card holder. The fine-grained option may be an option made available for a new account holder who may wish, to limit fraud risk or even avoid temptation to over-spend the transferred funds. Likewise the financial institution may offer to keep some limits and/or restrictions in place to reduce risk of fraud or over-spending against the transferred funds.

Advantages

A number of advantages wilt be understood from the above description of the embodiments of the present invention.

In particular, a system and method are provided for pre-registering details of an account holder's next of kin to enable efficient and secured transfer of authorization to access a financial account. The primary account bolder and the nominated, authorized, successor can advantageously pre-register required details in advance of the account succession, and the account management system 3 is configured to ensure that a voice print is stored for the nominated successor such that the subsequent account succession process is efficient yet secured. Pre-registration of a power of attorney or next of kin's biometric profile at any time prior to a bereavement or incapacitating event, and subsequent maintenance by the financial institution of the biometric profile, effectively increases the confidence of the financial institution of both the testator's wishes and also the validity of the claimant to be a successor to an estate.

Additionally, data integrity of both the existing primary account and the nominated successor account are maintained throughout the account succession process. This maintains the financial institution's ability to audit both accounts, and wind back transactions in the event of an error.

Moreover, the financial institution can be pro-active in it's dealings with the successor based on knowledge of the event from media (e.g. press association news feed) or social media updates from the testator's accounts or known associates (such as registered successors).

Computer Systems

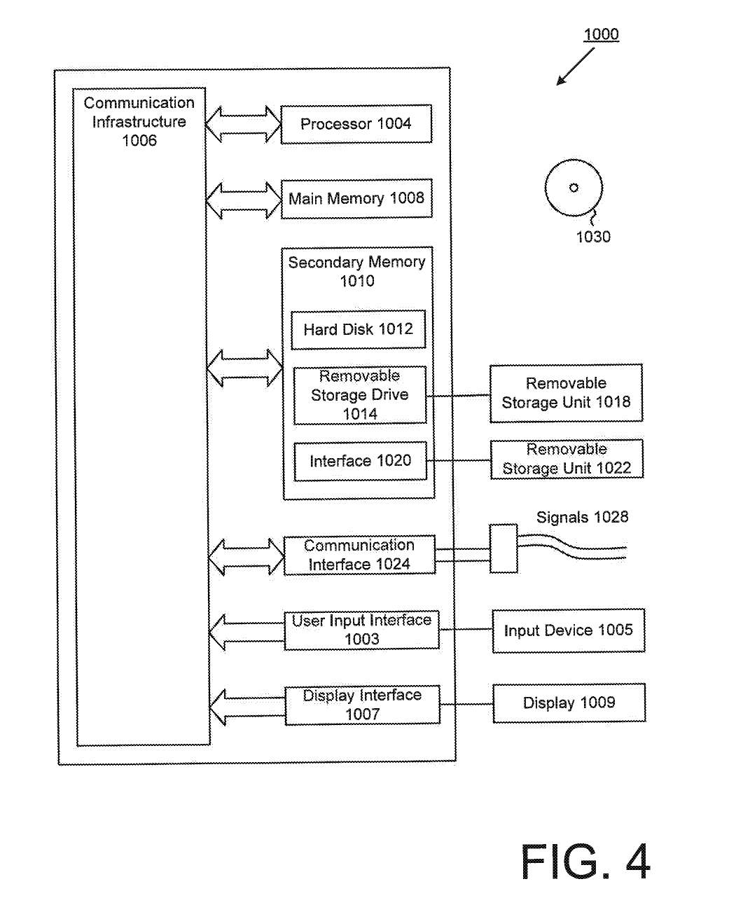

The account management system described herein may be implemented by one or more computer systems such as a computer system 1000, as shown in FIG. 4. Embodiments of the present invention may be implemented as programmable code lot execution by such computer systems 1000. After reading this description, it will become apparent to a person skilled in the art how to implement the invention using other computer systems and/or computer architectures.

The computer system 1000 includes one or more processors, tor example, a single processor 1004. The processor 1004 may be any type of processor, including but not limited to a special purpose or a general-purpose digital signal processor. The processor 1004 is connected to a communication infrastructure 1006 (for example, a bus or network), Various software implementations are described in terms of this exemplary computer system. After reading this description, it will become apparent to a person skilled in the art how to implement the invention using other computer systems and/or computer architectures.

The computer system 1000 also includes a user input interface 1003 connected to one or more input device(s) 1005 and a display interface 1007 connected to one or more display(s) 1009. The input devices 1005 may include, for example, a pointing device such as a mouse or touchpad, a keyboard, a touchscreen such as a resistive or capacitive touchscreen, etc. After reading this description, it will become apparent to a person skilled in the art how to implement the invention using other computer systems and/or computer architectures, for example using mobile electronic devices with integrated input and display components.

The computer system 1000 also includes a main memory 1008, preferably random access memory (RAM), and may also include a secondary memory 1010. The secondary memory 1010 may include, for example, a hard disk drive 1012 and/or a removable storage drive. 1014, representing a floppy disk drive, a magnetic tape drive, an optical disk drive, etc. the removable storage drive 1014 reads from and/or writes to a removable storage unit 1018 in a well-known manner. The removable storage unit 1018 represents a floppy disk, magnetic tape, optical disk, etc., which is read by and written to by the removable storage drive 1014. As will be appreciated, the removable storage unit 1018 includes a comparer usable storage medium having stored therein computer software and/or data.

In alternative implementations, the secondary memory 1010 may include other similar means for allowing computer programs or other instructions to be loaded into the computer system 1000. Such means may include, for example, a removable storage unit 1022 and an interface 1020. Examples of such means may include a program cartridge and cartridge interface (such as that previously found in video game devices), a removable memory chip (such as an EPROM, or PROM, or flash memory) and associated socket, and other removable storage units 1022 and interfaces 1020 which allow software and data to be transferred from the removable storage unit 1022 to the computer system 1000. Alternatively, the program may be executed and/or the data accessed from the. removable storage unit 1022, using the processor 1004 of the computer system 1000.

The computer system 1000 may also include a communication Interface 1024. The communication interface 1024 allows software and data to he transferred between the computer system 1000 and external devices. Examples of the communication interface. 1024 may include a modem, a network interface (such as an Ethernet card), a communication port, a Personal Computer Memory Card International Association (PCMCIA) slot and card, etc. Software and data transferred via communication interface 1024 are in the form of signals 1028, which may be electronic, electromagnetic, optical, or other signals capable of being received by the communication interface. 1024. These signals 1028 are provided to the communication interface 1024 via a communication path 1026. The communication path 1026 carries signals 1028 and may be implemented using wire or cable, fibre optics, a phone line, a wireless link, a cellular phone link, a radio frequency link, or any other suitable communication channel, For instance, the communication path 1026 may be implemented using a combination of channels,

The terms “computer program medium” and “computer usable medium” are used generally to refer to media such as a removable storage drive 1014, a hard disk installed in the hard disk drive 1012, and signals 1028. These computer program products are means for providing software, to the computer system 1000. However, these terms may also include signals (such as electrical, optical or electromagnetic signals) that embody the computer program disclosed herein.

The computer programs (also called computer control logic) are stored in the main memory 1008 and/or the secondary memory 1010. The computer programs may also be received via communication interface 1024. The computer programs, when executed, enable the computer system 1000 to implement embodiments of the present invention as discussed herein. Accordingly, such computer programs represent controllers of the computer system 1000. Where the embodiment is implemented rising software, the software may be stored in a computer program product 1030 and loaded into the computer system 1000 using the removable storage drive 1014, the hard disk drive 1012, or the communication interface 1024, to provide, some examples.

Alternative embodiments may be implemented as control logic in hardware, firmware, or software or any combination thereof.

### ALTERNATIVE EMBODIMENTS

It will be understood that embodiments of the present invention are described herein by way of example only, and that various changes and modifications may be made without departing from the scope of the invention.

For example, in the embodiments described above, the account management system is associated with a financial institution and stores account data for a plurality of financial accounts. As those skilled in the art will appreciate, the system and method for pre-registering an authorized successor and (or effecting account succession can be applied to management of accounts that are not necessarily associated with a financial institution. For example, the described techniques can be applied to controlling succession of any other form of user account, such as an email account, a loyalty scheme account, a membership account, etc.

What is claimed is:

1. A system for secured succession of a user account to an authorised successor, comprising:
a database storing data identifying a successor for an account of a registered account holder and associated data defining a biometric signature of the successor.
a verification module configured to verify an identity of the successor based on the biometric signature of the successor; and
an account succession module configured to receive an instruction to transfer the account to the successor, and to transfer the account to the successor after verification of the successor by the verification module.

2. The system of claim 1, further comprising a registration module for receiving data identifying the successor for the account.

3. The system of claim 2, wherein the registration module is further configured to determine whether the successor is an existing registered user of the system and in response to a determination that the successor is an existing registered user of the system, storing data linking the account to the successor.

4. The system of claim 2, wherein the registration module is further configured to determine whether the successor is not an existing registered user of the system and in response to a determination that the successor is not an existing registered user of the system, to receive and store associated data defining a biometric signature of the successor.

5. The system of claim 1, wherein the biometric signature is a voice signature.

6. The system of claim 5, wherein the verification module is further configured to receive an input voice sample and to compare the input voice sample with the voice signature to verify the identity of the successor.

7. The system of claim 6, wherein the input voice sample is captured during an initial greeting session.

8. The system of claim 1, wherein the verification module is configured to determine a level of verification required.

9. The system of claim 1, further comprising a data aggregator module for monitoring and providing data associated with a candidate event associated with the registered account holder.

10. The system of claim 9, wherein the account transfer module is further configured to determine from data provided by the data aggregator module that the candidate event necessitates account succession, and in response a determination that the candidate event has occurred, to initiate contact with the successor.

11. The system of claim 1, wherein the account transfer module is further configured to convert or migrate the account to a successor account of the successor and to enable restricted access to account services.

12. The system of claim 11, wherein the account is a financial account of a financial institution associated with an amount of funds.

13. The system of claim 12, wherein converting or migrating the account to the successor comprises transferring control of access to the financial account to the successor.

14. The system of claim 12, wherein converting the financial account comprises transferring associated funds and payment artifacts to the successor account.

15. The system of claim 12, wherein enabling restricted access includes placing a limitation on an amount or a frequency of transactions.

16. The system of claim 11, wherein the successor account is a Payable on Death (POD) account.

17. The system of claim 11, wherein the successor account is configured to receive data indicative of official clearance of the registered successor to receive an unrestricted access to account services.

18. The system of claim 17, wherein the data indicative of official clearance comprises one or more of a Grant of Representation, a Probate Court access order, a waiver of probate, indemnity, a Power of Attorney, and a Revenue Commission clearance.

19. The system of claim 1, further comprising a voice portal module for iteratively updating the voice signature based on voice-based interactions by the successor with the system.

20. The system of claim 19, wherein the voice portal module is further configured to augment the voice signature by a variance prediction model to take into account predicted changes to the voice signature.

21. The system of claim 1, wherein the verification module is further configured to verify the identity of the successor based on a six factor authentication comprising identification data representative of something the system predicts, something the system finds out, something the system infers, something a person is, something a person knows, and something a person has.

22. The system of claim 1, wherein the system comprises a network gateway module for handling interactions with a computing device and a computer telephony integration module for handling interactions with a telephone.

23. A computer-implemented method for secured succession, of a user account to an authorized successor, comprising the steps of:
storing data on a computing device Identifying a registered successor for an account and associated data defining a voice signature of said registered successor;
verifying the identity of said registered successor based on the voice signature;
receiving an instruction to transfer said account to the registered successor; and
transferring the account to the registered successor after verification of the identity of said successor.
